(19) United States
(12) Patent Application Publication
(10) Pub. No.: US 2004/0227456 A1
(43) Pub. Date: Nov. 18, 2004

(54) Display apparatus

(75) Inventor: Shinzo Matsui, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Shibuya-ku (JP)

(21) Appl. No.: 10/843,653

(22) Filed: May 11, 2004

(30) Foreign Application Priority Data
May 15, 2003 (JP) 2003-137485

(51) Int. Cl. H01J 63/04

(52) U.S. Cl. 313/501

(57) ABSTRACT

A display apparatus which displays an image to an observer by using an optical modulation device which performs optical modulation in accordance with inputted image data, comprises a plurality of light emitters configured to emit different color light beams whose light emission quantities are adjustable, and a light intensity adjustment control portion configured to individually adjust and control the light emission quantities of the respective color light beams emitted by the plurality of light emitters. The light intensity adjustment control portion can change a light emission quantity of at least one color light beam to a light emission quantity smaller than the light emission quantities of the respective color light beams from the plurality of light emitters when a white image having a maximum brightness which can be displayed is displayed to an observer.

### CROSS-REFERENCE TO RELATED APPLICATIONS

This application is based upon and claims the benefit of priority from prior Japanese Patent Application No. 2003-137485, filed May 15, 2003, the entire contents of which are incorporated herein by reference.

### BACKGROUND OF THE INVENTION

1. Field of the Invention

The present invention relates to a display apparatus which displays an image to an observer by using an optical modulation device which performs optical modulation in accordance with image data inputted thereto.

2. Description of the Related Art

As projection display apparatuses, there have been conventionally known an overhead projector (OHP), a slide projector, data projector and others.

In recent years, a utilization ratio of a data projector is greatly increased with a progress in personal computers or popularization of presentation software. Further, with a progress in an optical modulation device, a reduction in size of the data projector has advanced, a usage scene of the data projector has extended, and the data projector is used in sessions or the like for a small number of people. For example, there has become widespread a scene that a white board is used as a screen with a projection image whose size is approximately 40 inches which is relatively smaller than a conventional image and a session is carried out.

Many data projectors have a focus adjusting function and can change a size of a projection image in accordance with a distance between a screen and the data projector. However, a brightness on a screen surface becomes low as a projection image is large and it becomes high more than needs as the projection image is small depending on a difference in size of the projection image.

Furthermore, as light sources of the data projector, various kinds of lamps such as a high pressure mercury lamp are used in order to obtain a bright projection image with a large light emission quantity. In case of the data projector, the brightness can be changed by varying optical modulation data which is supplied to an optical modulation device. However, since the lamp is hard to adjust the brightness, a power consumption by the lamp is not reduced in accordance with a change in brightness due to a variation in optical modulation data. Therefore, a large power is consumed. That is, in the conventional data projector, a light source such as a xenon lamp or a high pressure mercury lamp consumes a large part of power for the entire apparatus, and the lamp consumes several-hundred W.

On the contrary, in recent years, a light emitting diode (LED) has greatly technologically changed, and color light beams of red, blue (G) and green (B) can be emitted by a development of a blue LED and they have been used for color images like those in a large-screen display panel using LEDs for R, G and B. Moreover, realization of a higher brightness has also advanced, and it is expected in a light source for a projection display apparatus. As compared with lamps, the LED is known in a point that a light intensity adjustment can be readily instantaneously controlled by a control over a supply current.

On the other hand, the LED has a problem in that a light emission quantity varies in relation to manufacture irregularities, a temperature, a supply current or the like. A technique which solves such a problem is disclosed in U.S. Pat. No. 6,069,676. That is, in a color display apparatus in which LEDs for R, G and B are used for the backlight of a liquid crystal display panel, each light intensity is detected by a light sensor in order to form a constant brightness balance of R, G and B, and the brightness balance is controlled.

Additionally, Jpn. Pat. Appln. KOKAI Publication No. 2003-36063 discloses a video display apparatus which dynamically controls a light intensity of a light source in accordance with inputted image data.

### BRIEF SUMMARY OF THE INVENTION

According to an aspect of the present invention, there is provided a display apparatus which displays an image to an observer by using an optical modulation device which performs optical modulation in accordance with inputted image data, comprising:

a plurality of light emitters configured to emit different color light beams whose light emission quantities are adjustable; and

a light intensity adjustment control portion configured to individually adjust and control the light emission quantities of the respective color light beams emitted by the plurality of light emitters,

the light intensity adjustment control portion being able to change a light emission quantity of at least one color light beam to a light emission quantity smaller than the light emission quantities of the respective color light beams from the plurality of light emitters when a white image having a maximum brightness which can be displayed is displayed to an observer.

According to an another aspect of the present invention, there is provided a display apparatus which displays an image to an observer by using an optical modulation device which performs optical modulation in accordance with inputted image data, comprising:

a plurality of light emitters for emitting different color light beams whose light emission quantities are adjustable; and

light intensity adjustment control means for individually adjusting and controlling the light emission quantities of the respective color light beams emitted by the plurality of light emitters,

the light intensity adjustment control means being able to change a light emission quantity of at least one color light beam to a light emission quantity smaller than the light emission quantities of the respective color light beams from the plurality of light emitters when a white image having a maximum brightness which can be displayed is displayed to an observer.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an exterior appearance of a projection display apparatus as a first embodiment of a display apparatus according to the present invention;

FIG. 2 is a plane view showing an operation panel;

FIG. 3 is a function block diagram showing a structure of the projection display apparatus;

FIG. 4 is a block diagram showing a structure of a supply current adjustment control portion;

FIG. 5 is a view showing a relationship between a supply current ratio k and a brightness (power) for illustrating characteristics of respective LEDs for R, G and B;

FIG. 6 is a view likewise showing a relationship between a brightness ratio Lc and the supply current ratio k;

FIG. 7 is a view showing a structure of a projection display apparatus as a second embodiment of a display apparatus according to the present invention;

FIG. 8 is a view showing a layout of a plurality of LEDs on an LED substrate;

FIG. 9 is a view showing a timing chart illustrating a light intensity adjustment method in the projection display apparatus according to the second embodiment;

FIG. 10 is a timing chart illustrating another light intensity adjustment method;

FIG. 11 is a view illustrating a relationship between a power converted into heat by LEDs and a supply current;

FIG. 12 is a plane view showing an operation panel in a projection display apparatus as a third embodiment of the display apparatus according to the present invention;

FIG. 13 is a block diagram showing structures of a supply current adjustment control portion and an optical modulation device control portion;

FIG. 14 is a view showing a relationship between an image analysis content, an analysis result and data scaling factors in each energy saving mode;

FIG. 15A is a view showing input data iData and output data oData in a frame F1 in an energy saving mode M1 with respect to a scale conversion portion;

FIG. 15B is a view likewise showing input data iData and output data oData in a frame F2;

FIG. 16 is a view showing a timing chart illustrating a light intensity adjustment method in the energy saving mode M1;

FIG. 17A is a view showing input data iData and output data oData in the frame F1 in a energy saving mode M2 with respect to the scale conversion portion;

FIG. 17B is a view likewise showing input data iData and output data oData in the frame F2;

FIG. 18 is a view showing a timing chart illustrating a light intensity adjustment method in the energy saving mode M2;

FIG. 19 is a view showing a histogram of the input data iData illustrating the light intensity adjustment method in an energy saving mode M3;

FIG. 20 is a block diagram showing a structure of an optical modulation device control portion in a modification of the third embodiment;

FIG. 21A is a view illustrating a content of an image correction table for a scale 1 of the optical modulation device control portion;

FIG. 21B is a view illustrating a content of the image correction table for a scale 4/3 of the optical modulation device control portion;

FIG. 21C is a view illustrating a content of the image correction table for a scale 2 of the optical modulation device control portion;

FIG. 22 is a view illustrating selection conditions of the image correction table used by a selection circuit of the optical modulation device control portion;

FIG. 23 is a view showing a timing chart illustrating the light intensity adjustment method in a modification; and

FIG. 24 is a block diagram showing a structure of an optical modulation device in another modification of the third embodiment.

### DETAILED DESCRIPTION OF THE INVENTION

Embodiments according to the present invention will now be described hereinafter with reference to the accompanying drawings.

[First Embodiment]

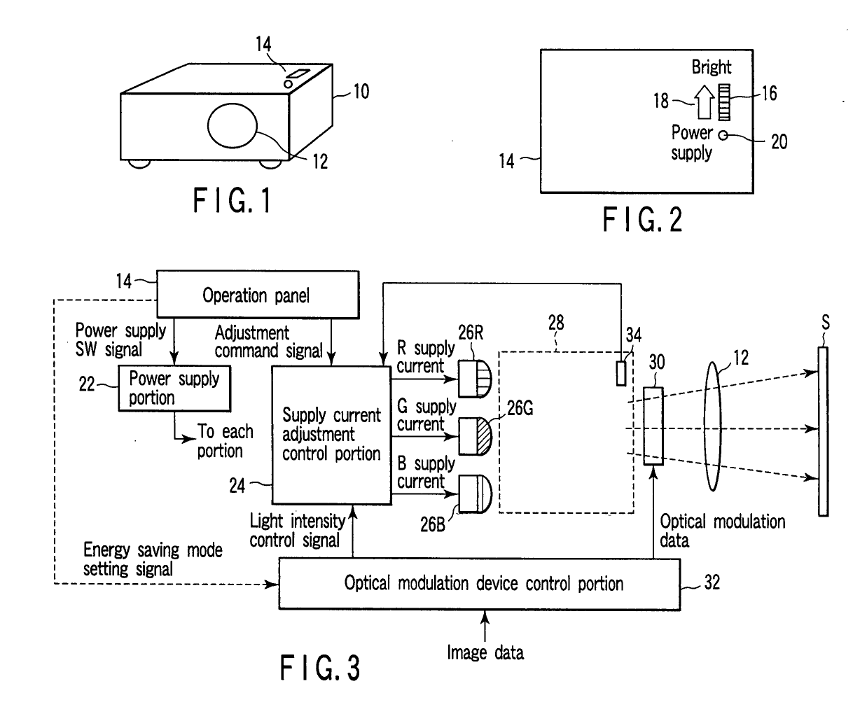

As shown in FIG. 1, a projection optical system 12 which is used to project an image is arranged on a front surface of a projection display apparatus 10 as a first embodiment of a display apparatus according to the present invention. Further, an operation panel 14 which is operated by an operator is provided on a top surface of the same.

As shown in FIG. 2, a rotary light intensity adjustment knob 16 which is used to adjust a light intensity by an operation of an operator is arranged on this operation panel 14. An index 18 which is used to indicate an operation direction and an operation result of the rotary light intensity adjustment knob 16 is provided in the vicinity of this rotary light intensity adjustment knob 16 by printing or the like. As indicated by this index 18, by rotating the rotary light intensity adjustment knob 16 in an upward direction in the drawing, a projection light intensity obtained by the projection optical system 12 is increased, and an image is more brightly projected. Furthermore, when the rotary light intensity adjustment knob 16 is kept being rotated in the upward direction, it enters a state in which the rotating operation is impossible. At this time, it is possible to display a white image with a maximum brightness which can be displayed in this apparatus. On the contrary, when the knob 16 is rotated in a downward direction, an image is more darkly projected. In this manner, a light intensity can be appropriately adjusted by the simple operation, and the operation is enabled so as to display an image with a projection light intensity which is required in a projection environment.

Furthermore, the rotary light intensity adjustment knob 16 also has a function as a power supply switch of the projection display apparatus 10 as well as such a light intensity adjustment function. That is, when this rotary light intensity adjustment knob 16 is operated to rotate to a final position in a direction (downward direction in the drawing) opposed to a direction of an arrow of the index 18, a power supply of the projection display apparatus 10 can be turned off. Moreover, when the rotary light intensity adjustment knob 16 is operated to rotate in the direction of the arrow of the index 18, i.e., the upward direction in the drawing from that state, the power supply of the projection display apparatus 10 can be turned on. In order to present the on/off state of this power supply to an operator, a power supply LED 20 is arranged in the vicinity of the rotary light intensity adjustment knob 16.

The projection display apparatus 10 has such a structure as shown in FIG. 3. That is, a power supply SW signal is supplied from the operation panel 14 to a power supply portion 22 in accordance with ON of the power supply obtained by operating the rotary light intensity adjustment knob 16 on the operation panel 14. This power supply portion 22 supplies a necessary power to each portion in the projection display apparatus 10 in response to the power supply SW signal. Additionally, an adjustment command signal according to a rotational position of the rotary light intensity adjustment knob 16 on the operation panel 14 is supplied to a supply current adjustment control portion 24 which functions as a light intensity adjustment control portion.

Here, this projection display apparatus 10 comprises an R-LED 26R, a G-LED 26G and a B-LED 26B as a plurality of light emitters which emit different color light beams (R, G and B) whose light emission quantities can be adjusted. It is to be noted that different types of hatching are provided in order to identify respective colors in FIG. 3, and they are different from hatching which shows a cross section (which is also true in other drawings). Further, the light emitters are not restricted to such LEDs, and any other light emitting elements such as organic LEDs (OLEDs) may be used. Furthermore, the supply current adjustment control portion 24 adjusts a current to be supplied to each of the R-LED 26R, the G-LED 26G and the B-LED 26B in accordance with the adjustment command signal received from the operation panel 14, thereby individually adjusting and controlling light emission quantities of the LEDs for the respective colors.

Light beams from the R-LED 26R, the G-LED 26G and the B-LED 26B are applied to an optical modulation device 30 through an illumination optical system 28. Here, input image data as data to be displayed is inputted to an optical modulation device control portion 32. This optical modulation device control portion 32 supplies optical modulation data according to the inputted image data to the optical modulation device 30. It is to be noted that a two-dimensional micromirror deflection array which is known under a trademark of DMD (digital micromirror device), a transmission liquid crystal, a reflection liquid crystal or the like can be used as the optical modulation device 30. Moreover, the optical modulation data is image data itself to be supplied to the optical modulation device 30, and it may be inputted image data or converted data. That is, any kinds of data can be used as long as it is data with which a projection image corresponding to inputted image data can be consequently obtained.

The optical modulation device 30 performs optical modulation in accordance with optical modulation data inputted thereto. Then, the optically modulated light beams are projected onto a screen S by the projection optical system 12. As a result, a projection image corresponding to the input image data is projected and displayed on the screen S.

Additionally, a light sensor 34 which is used to detect light emission quantities of the LEDs is arranged at a position which does not obstruct illumination of the optical modulation device 30. The supply current adjustment control portion 24 feedback-controls a supply current for each of the LEDs 26R, 26G and 26B in accordance with a light intensity detected by the light sensor 34.

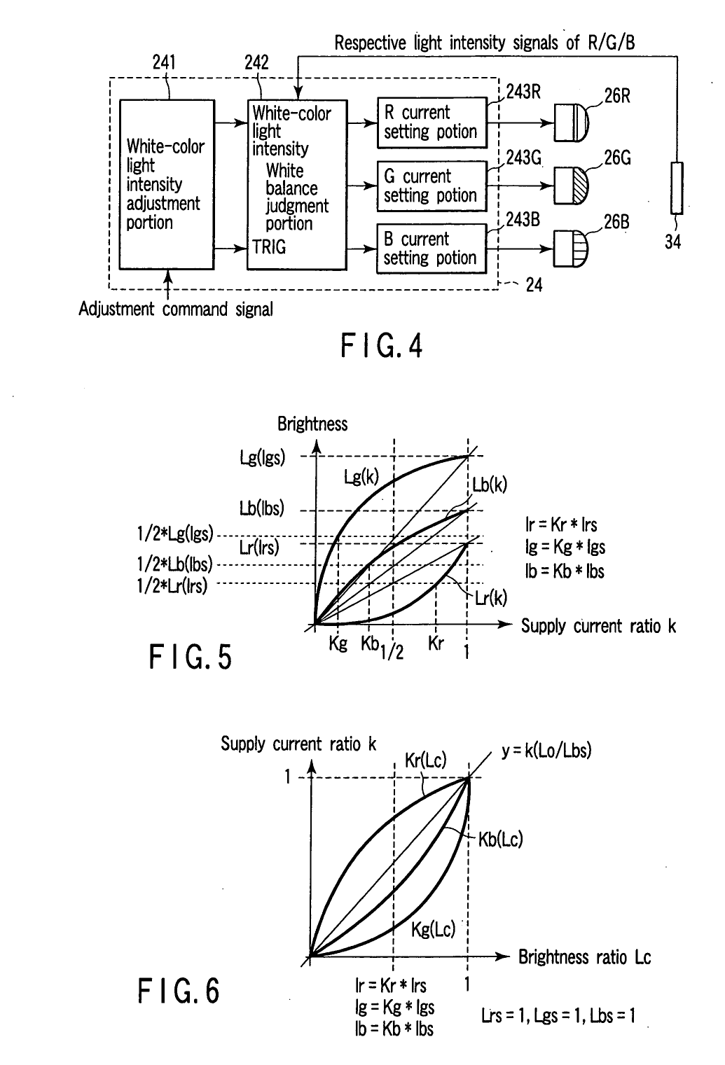

As shown in FIG. 4, the supply current adjustment control portion 24 is constituted of a white-color light intensity adjustment portion 241, a white balance judgment portion 242, an R current setting portion 243R, a G current setting portion 243G and a B current setting portion 243B. The white-color light intensity adjustment portion 241 sets in the white balance judgment portion 242 a white-color light intensity according to an adjustment command signal inputted from the operation panel 14. The white balance judgment portion 242 calculates current values required for the R-LED 26R, the G-LED 26G and the B-LED 26B, and sets them in the R current setting portion 243R, the G current setting portion 243G and the B current setting portion 243B. In accordance with this operation, the LEDs 26R, 26G and 26B for respective color light beams are turned on. At that time, the light sensor 34 detects a light intensity of each of R, G and B, applies feedback, and adjusts each current value so as to obtain a desired white-color light intensity.

This white balance adjustment is carried out when the rotary light intensity adjustment knob 16 on the operation panel 14 is operated. Therefore, a trigger signal (TRIG) which directs start of the white balance adjustment is supplied to the white balance judgment portion 242 by the white-color light intensity adjustment portion 241.

As characteristics of the respective LEDs 26R, 26G and 26B for R, G and B, a relationship between a supply current ratio k and a brightness (power) is as shown in FIG. 5, and a relationship between a brightness ratio Lc and the supply current ratio k is as shown in FIG. 6. Here, as to the supply current ratio k, a supply current of each of the LEDs 26R, 26G and 26B for R, G and B is determined as “1” when displaying a white image with a maximum brightness in the apparatus. The brightness ratio Lc is also determined as “1” in such a case.

As apparent from FIG. 5, when performing display with a brightness which is ½ of that of a white image with the maximum brightness by the light intensity adjustment, the supply current ratios to be supplied to the respective LEDs 26R, 26G and 26B for R, G and B which are used to maintain the white balance and perform display are different from each other like kr, kg and kb. When the brightness of the white image is changed based on a difference in characteristics of the respective LEDs 26R, 26G and 26B for R, G and B, the supply current which differs in accordance with each of the LEDs for R, G and B must be controlled in place of the supply current which is linear with respect to this change. Thus, in this embodiment, as shown in FIG. 4, light intensities of R, G and B are individually measured by the light sensor 34, and a desired brightness and white balance are adjusted in the white image. Here, the desired brightness means a brightness of a light source (light emitter) which displays with a maximum light intensity which can be set in the apparatus a white image with a desired color temperature.

Further, a light intensity which is emitted from the light source of the projection display apparatus 10 varies depending on a deterioration of the LEDs or a difference in working temperature. Therefore, the maximum light intensity of the white image which can be set in the projection display apparatus 10 means a maximum light intensity which satisfies both conditions which previously specify maximum current values of the supply currents for the respective LEDs 26R, 26G and 26B and maintain the specified values in the respective LEDs 26R, 26G and 26B, and maintenance of the balance of the respective light intensities of R, G and B.

It is to be noted that a maximum light intensity in the operation of the rotary light intensity adjustment knob 16 on the operation panel 14 is the maximum light intensity of the white image. Furthermore, when performing display by lowering the light intensity of the white image in accordance with a rotating operation of the rotary light intensity adjustment knob 16, the white balance judgment portion 242 judges and sets the respective supply currents of R, G and B required for the white balance by using the light sensor 34.

As described above, according to the first embodiment, a light emission quantity can be adjusted by an adjustment command from an operator in accordance with a brightness of outside light in a place where the apparatus is used or an image size to be projected.

Moreover, even if there is a difference in characteristics of the plurality of light emitters which emit difference color light beams (R, G and B), the white balance is not lost by the light intensity adjustment. Therefore, the white balance of an image to be displayed can be stably adjusted.

Additionally, as a projection display apparatus, realization of a reduction in power consumption is enabled by using light emitters such as LEDs as light sources in an apparatus which requires a high light intensity and a large screen, and a power consumption can be further reduced by the light intensity adjustment.

[Second Embodiment]

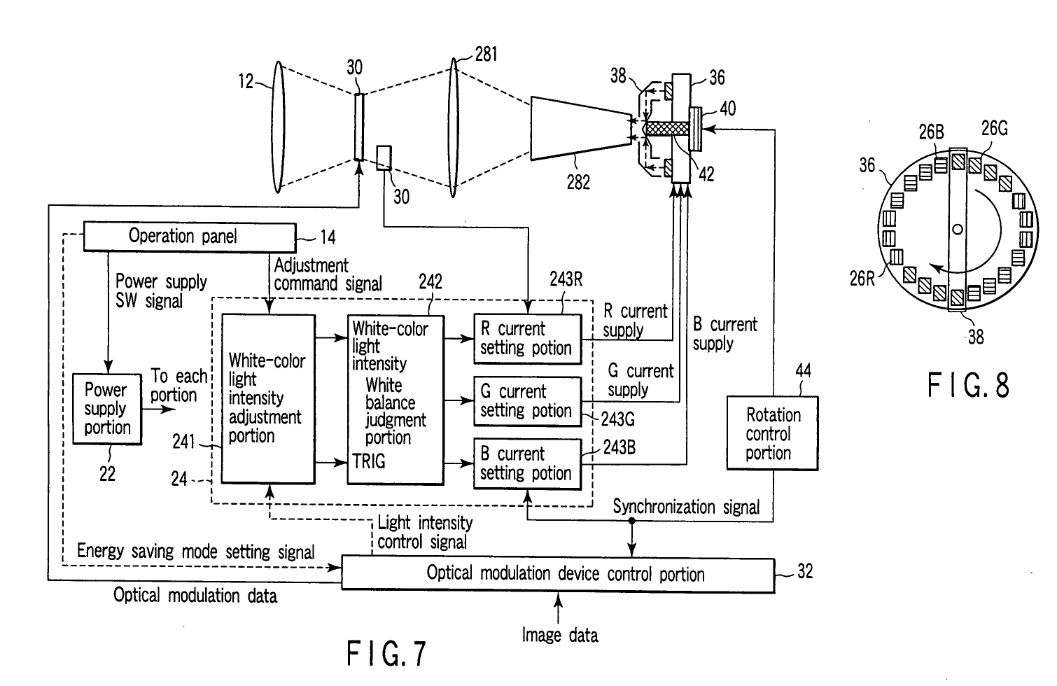

A structure of a projection display apparatus 10 as a second embodiment of the display apparatus according to the present invention is as shown in FIG. 7. It is to be noted that like reference numerals denote parts equal to those in FIG. 3. Therefore, the explanation about these parts is eliminated.

The projection display apparatus 10 in this embodiment comprises a plurality of LEDs for respective color light beams. That is, as shown in FIGS. 7 and 8, a plurality of LEDs 26R, 26G and 26B for R, G and B are arranged in a ring-like form on an LED substrate 36 which functions as a light source holding portion. In this case, a predetermined number of LEDs for the same color light beams are continuous in accordance with each color light beams, three-color light beams of R, G and B can be obtained with a half circle, and the plurality of LEDs 26R, 26G and 26B are arranged in such a manner that the LEDs for the same color light beams appear at positions opposed to each other at 180°. Further, supply currents of the respective LEDs are set by the supply current adjustment control portion 24, and the LEDs are controlled to sequentially perform pulse lighting.

Furthermore, a light leading member 38 which rotates in synchronization with the pulse lighting of the LEDs is arranged between an incident surface of a taper rod 282 which constitutes an illumination optical system 28 with an illumination lens 281 and the LEDs. That is, the light beams from the LED which performs pulse lighting are led to the taper rod 282 by this light leading member 38, and the diffused light beams with a large NA have its NA reduced by the taper rod 282, and then applied to the optical modulation device 30 by the illumination lens 281.

Moreover, the light leading member 38 is attached to a rotary shaft 42 of a motor 40. Therefore, the rotation of the light leading member 38 is performed with the rotation of the motor 40. The rotation of this motor 40, i.e., the rotation of the light leading member 38 is controlled to have a stable rotational speed by a rotation control portion 44 which function as a drive control portion. Additionally, in synchronization with this rotation, the optical modulation device control portion 32 generates optical modulation data which is supplied to the optical modulation device 30 from inputted image data. Further, in synchronization with the rotation control portion 44, the supply current adjustment control portion 24 controls currents to be supplied to the respective LEDs for R, G and B.

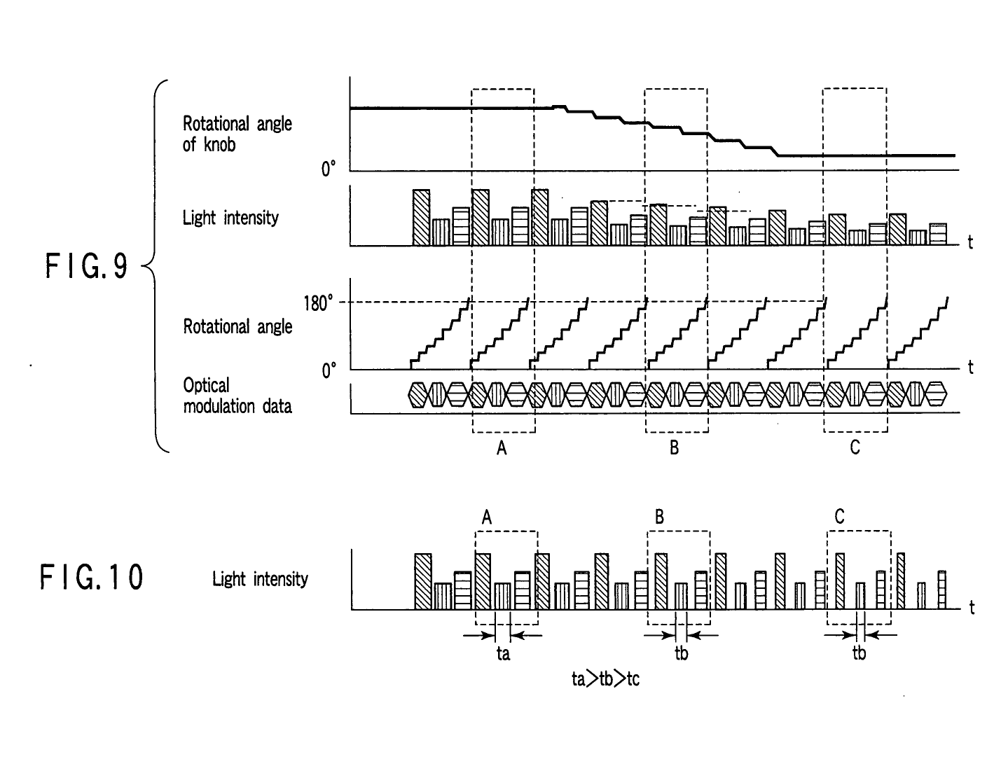

An operation of the projection display apparatus 10 according to this embodiment having the above-described structure will now be described with reference to a timing chart depicted in FIG. 9. It is to be noted that a rotation angle means a rotation angle with respect to a given starting point of the light leading member 38 in the drawing.

In this embodiment, a light intensity is adjusted with RGB being determined as one set. That is, the operation panel 14 detects a rotation quantity of the rotary light intensity adjustment knob 16 such as indicated as a rotation angle of the knob in FIG. 9 with a predetermined timing, e.g., in synchronization with a vertical synchronization signal of inputted image data. Then, it supplies a detection result to the supply current adjustment control portion 24 as an adjustment command signal. The supply current adjustment control portion 24 adjusts and controls light emission quantities of the respective LEDs for R, G and B in accordance with an adjustment command signal.

At this time, as shown in a graph of FIG. 5, the white balance cannot be maintained constant even if the supply current of each of R, G and B is controlled in equal ratio. Therefore, light intensities of R, G and B are detected by the light sensor 34, and the supply currents which can be light emission quantities of the LEDs for the respective colors R, G and B are set while maintaining the brightness balance of R, G and B so as to obtain a desired white light intensity. In this case, it is to be noted that the graph of FIG. 5 is saved in an ROM in advance, the respective supply currents of R, G and B are calculated and set based on this graph, and errors with respect to desired light intensities of R, G and B are corrected by using the light sensor 34 in this embodiment. Of course, just setting the supply currents based on the graph saved in the ROM can suffice. Further, the ROM may not be included, and the supply currents may be changed little by little while detecting the light intensities by the light sensor 34. Furthermore, as a light intensity adjustment method, as shown in FIG. 10, the light intensities may be adjusted by changing a pulse lighting time.

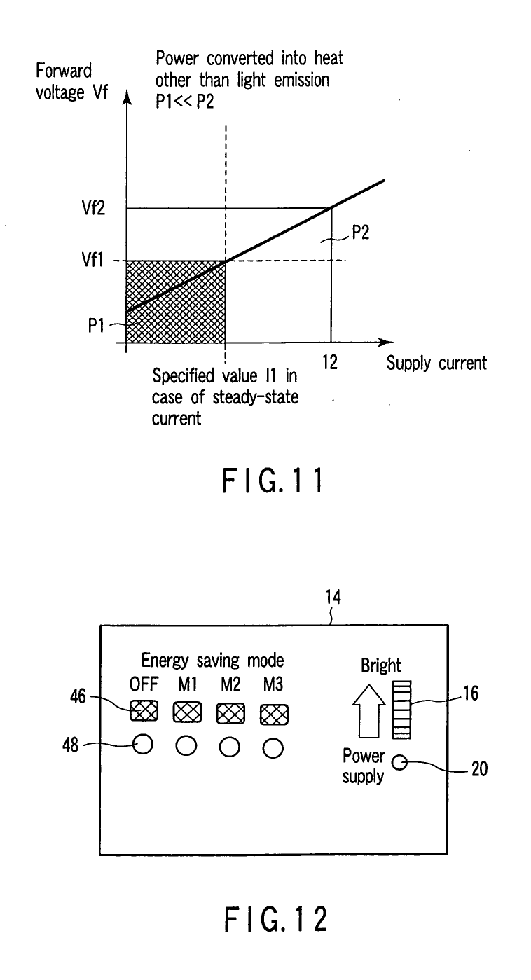

In the structure of this embodiment in which the LEDs are caused to emit light beams having a high brightness with large supply currents in the pulse light emission, the illumination with a high brightness can be obtained. However, as shown in FIG. 11, a power to be converted into heat is also large. Therefore, a power consumption which exceeds a decreasing light intensity can be lowered by reducing the supply currents.

As described above, according to the second embodiment, generation of heat of the LEDs can be suppressed by performing pulse lighting of the LEDs, and light beams can be instantaneously brightly emitted by passing currents with a large peak current. Moreover, continuous illumination light beams can be consequently obtained by performing pulse lighting of the plurality of LEDs with different timings, and the brighter illumination light beams can be obtained by serially outputting the illumination light beams which are instantaneously bright. In the apparatus which enables the bright illumination and display of an image, a reduction in power consumption can be achieved with less ineffectual light emission quantities. Additionally, generation of heat of the LEDs can be suppressed by controlling the supply currents to the LEDs, and the light emission efficiency can be improved, and a reduction in power consumption can be realized. Further, light intensities can be adjusted with less affect of individual characteristics of the LEDs. Furthermore, since light beams can be emitted without discontinuing the pulse light emission from the plurality of LEDs as much as possible, the brighter illumination and image can be obtained.

[Third Embodiment]

In a projection display apparatus 10 according to this embodiment, as indicated by broken lines in FIG. 3 or FIG. 7, an energy saving mode setting signal is supplied from the operation panel 14 to the optical modulation device control portion 32, and a light intensity control signal is supplied from the optical modulation device control portion 32 to the supply current adjustment control portion 24. That is, as shown in FIG. 12, on the operation panel 14 of the projection display apparatus 10 in the third embodiment are arranged a plurality of setting buttons 46 and a plurality of setting confirmation LEDs 48 in addition to the rotary light intensity adjustment knob 16, the index 18 and the power supply LE 20. Here, the plurality of setting buttons 46 are buttons used by an operator to select and set an energy saving mode. Moreover, the plurality of setting confirmation LEDs 48 are provided in accordance with the respective setting buttons 46, and they are LEDs which shows an operator that the mode is set in accordance with an operation of a corresponding setting button 46. It is to be noted that four buttons, i.e., an OFF button, an M1 button, an M2 button and an M3 button are provided as the setting buttons 46 in this embodiment. An energy saving mode setting signal according to an operation of these buttons is supplied from the operation panel 14 to the optical modulation device control portion 32.

The projection display apparatus 10 in this embodiment has four operation modes in accordance with the number of setting buttons 46. That is, when the OFF button in the setting buttons 46 is operated, the same operation as that in the first or second embodiment is carried out as a mode OFF. On the contrary, when one of the M1 button, M2 button and the M3 button is operated, the operation is carried out in a corresponding energy saving mode M1, M2 or M3. Here, the energy saving mode M1 is a mode to perform the operation by detecting a maximum value of all data for R, G and B by image analysis. The energy saving mode M2 is a mode to perform the operation by detecting maximum values of all data for each of R, G and B by image analysis. Further, the energy saving mode M3 is a mode to perform the operation by detecting a histogram of all data for each of R, G and B by image analysis. Respective processing contents in these energy saving modes will be described later in detail.

It is to be noted that respective advantages are as follows. That is, in the energy saving mode M1, performing the control in equal ratio for maintaining the light intensities of R, G and B constant can suffice, and hence the control is simple. In the energy saving mode M2, the energy can be further saved as compared with the energy saving mode M1, thereby greatly reducing the light emission quantity in accordance with each of R, G and B. Furthermore, in the energy saving mode M3, the further energy saving is possible as compared with the energy saving mode M2, and the great energy saving is possible depending on images. For example, there is a case in which pixels with a high brightness are included in a dark image due to a so-called pixel defect of an imaging element of a camera when inputted image data is an image taken by the camera. In the energy saving mode M3, the pixels with a high brightness in such an image are converted to have a brightness equivalent to that of surrounding pixels, thereby reducing a light intensity corresponding to the brightness of the converted pixels.

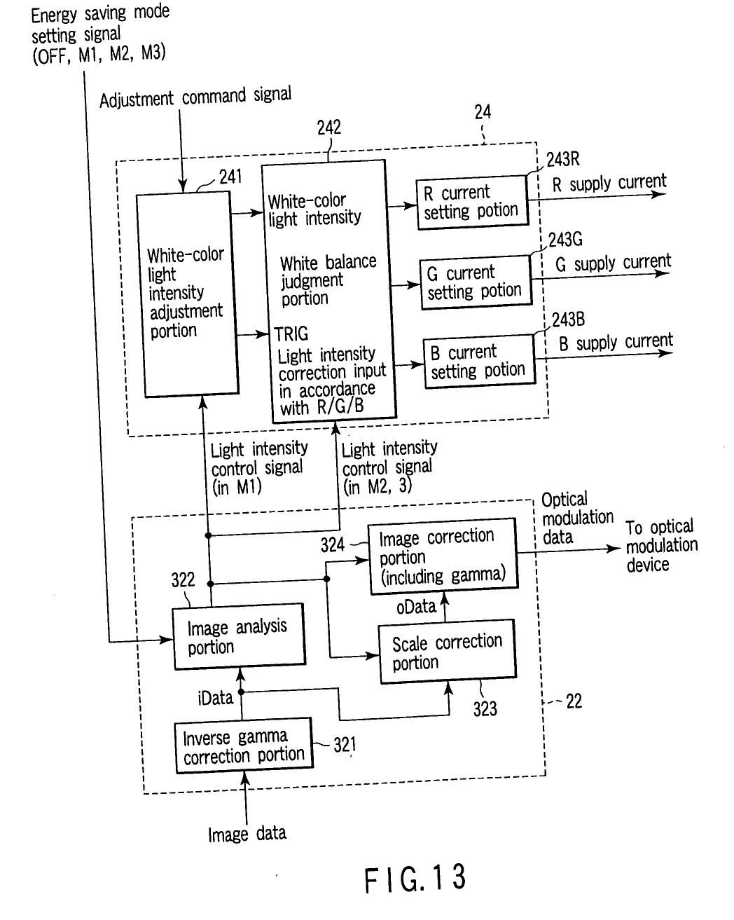

As described above, the supply current adjustment control portion 24 in this embodiment is constituted of the white-color light intensity adjustment portion 241, the white balance judgment portion 242, the R current setting portion 243R, the G current setting portion 243G and the B current setting portion 243B. Moreover, the optical modulation device control portion 32 in this embodiment is constituted of an inverse gamma correction portion 321, an image analysis portion 322, a scale conversion portion 323 and an image correction portion 324 as shown in FIG. 13.

Here, it is often the case that gamma correction is previously applied to image data inputted to the projection display apparatus 10, which is precisely the optical modulation device control portion 32, taking characteristics of a CRT or the like which is a usually utilized display device into consideration. Thus, in this embodiment, such inputted image data is first converted to linear image data by correcting in the inverse gamma correction portion 321 in order to facilitate calculation in the scale conversion portion 323. iData which is the corrected data is inputted from this inverse gamma correction portion 321 to the image analysis portion 322 and the scale conversion portion 323.

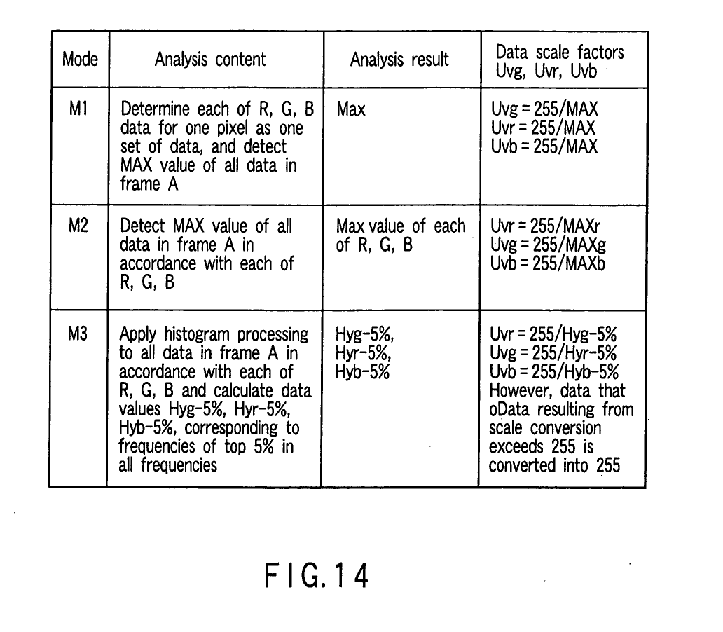

The image analysis portion 322 performs image analysis such as shown in FIG. 14 with respect to the inputted data iData in accordance with an energy saving mode setting signal from the operation panel 14. Then, it supplies data scale factors Uvg, Uvr and Uvb according to an image analysis result as light control signals to the scale conversion portion 323 and the image correction portion 324 which function as an optical modulation data change portion.

That is, in the energy saving mode M1 in which the M1 button in the setting buttons 46 is turned on, an MAX value is obtained as an analysis result by detecting an MAX value of all data in a frame A with data of each of R, G and B for one pixel being determined as one set of data. Additionally, Uvr=255/MAX, Uvg=255/MAX and Uvb=255/MAX are set to the data scale factors Uvr, Uvg and Uvb, and they are outputted as light intensity control signals.

Further, in the energy saving mode M2 in which the M2 button in the setting buttons 46 is turned on, MAX values MAXr, MAXg and MAXb for respective R, G and B are obtained as an analysis result by detecting MAX values of all data in the frame A in accordance with R, G and B. Furthermore, Uvr=255/MAXr, Uvg=255/MAXg and Uvb=255/MAXb are set to the data scale factors Uvr, Uvg and Uvb, and they are outputted as light intensity control signals.

Moreover, in the energy saving mode M3 in which the M3 button in the setting buttons 46 is turned on, histogram processing is applied to all data in the frame A in accordance with R, G and B, and data values Hyg-5%, Hyr-5% and Hyb-5% corresponding to frequencies of top 5% in entire frequencies are calculated, thereby obtaining Hyg-5%, Hyr-5% and Hyb-5% as an analysis result. Additionally, Uvr=255/Hyg-5%, Uvg=255/Hyr-5% and Uvb=255/Hyb-5% are set to the data scale factors Uvr, Uvg and Uvb, and they are outputted as light intensity control signals.

The scale conversion portion 323 changes a scale, i.e., a size of the data iData corrected in the inverse gamma correction portion 321 in accordance with the above-described light intensity control signal from the image analysis portion 322. Data oData scale-converted by this scale conversion portion 323 is inputted to the image correction portion 324. This image correction portion 324 applies image correction including the gamma to the inputted data oData in accordance with the light intensity control signals from the image analysis portion 322 and in accordance with the characteristics of the optical modulation device 30. Further, the image-corrected data is supplied to the optical modulation device 30 as optical modulation data. It is to be noted that the CRT or the like again applies the already applied gamma characteristics to the inputted image data, but this is not necessarily required. That is, correction is not required if the characteristics of the optical modulation device 30 are such that a size of the inputted optical modulation data and a brightness of the modulated light beams are linear.

Furthermore, the image analysis portion 322 supplies a light control signal according to the image analysis result to the white-color light intensity adjustment portion 241 or the white balance judgment portion 242 of the supply current adjustment control portion 24. Here, in case of the energy saving mode M1, the light control signal is inputted to the white-color light intensity adjustment portion 241 and subjected to the light intensity control in common with R, G and B. On the contrary, in the energy saving mode M2 or M3, the light control signal is inputted to the light intensity correction input for each of R, G and B of the white balance judgment portion 242, and the light intensity is controlled in accordance with each of R, G and B.

That is, the supply current adjustment control portion 24 receives the data scale factors Uvg, Uvr and Uvb as the light intensity control signals, and sets supply currents Iro, Igo and Ibo obtained by correcting standard supply currents Irs, Igs and Ibs in such a manner that the light intensities of G, R and B become 1/Uvg-, 1/Uvr- and 1/Uvb-fold of a reference value. At this time, the respective currents Iro, Igo and Ibo are not set to be 1/Uvg-, 1/Uvr- and 1/Uvb-fold of the respective supply currents corresponding to the light intensity reference value, but they are adjusted in such a manner that results obtained from the detection in the light sensor 34 become 1/Uvg-, 1/Uvr- and 1/Uvb-fold of the light intensity reference value.

Moreover, the present invention is not restricted to the above setting, but these values may be set taking the graph depicted in FIG. 6 into consideration.

Each mode will now be described in detail hereinafter.

In the mode OFF in which the OFF button in the setting buttons 46 is turned on, the image analysis portion 322 does not analyze the inputted data iData from the inverse gamma correction portion 321, but outputs the data scale factors Uvg, Uvr and Uvb as the light intensity control signals with “1”. As a result, the scale conversion portion 323 outputs the inputted data iData from the inverse gamma correction portion 321 as output data oData as it stands. Additionally, this data is corrected in the image correction portion 324, and then it is supplied to the optical modulation device 30 as optical modulation data. Further, the supply current adjustment control portion 24 performs the same operation as that in the first and second embodiments. That is, this mode OFF is a usual operation mode to perform the same operation as that in the first and second embodiment.

Furthermore, the energy saving mode M1 in which the M1 button in the setting buttons 46 is turned on is the mode to detect a maximum value of all data of R, G and B by image analysis and perform the operation as described above. Therefore, the image analysis portion 322 determines data of each of R, G and B for one pixel as one set of data, detects the MAX value of all data of the inputted data iData from the inverse gamma correction portion 321, and outputs the data scale factors Uvg, Uvr and Uvb as the light intensity control signals having the same value.

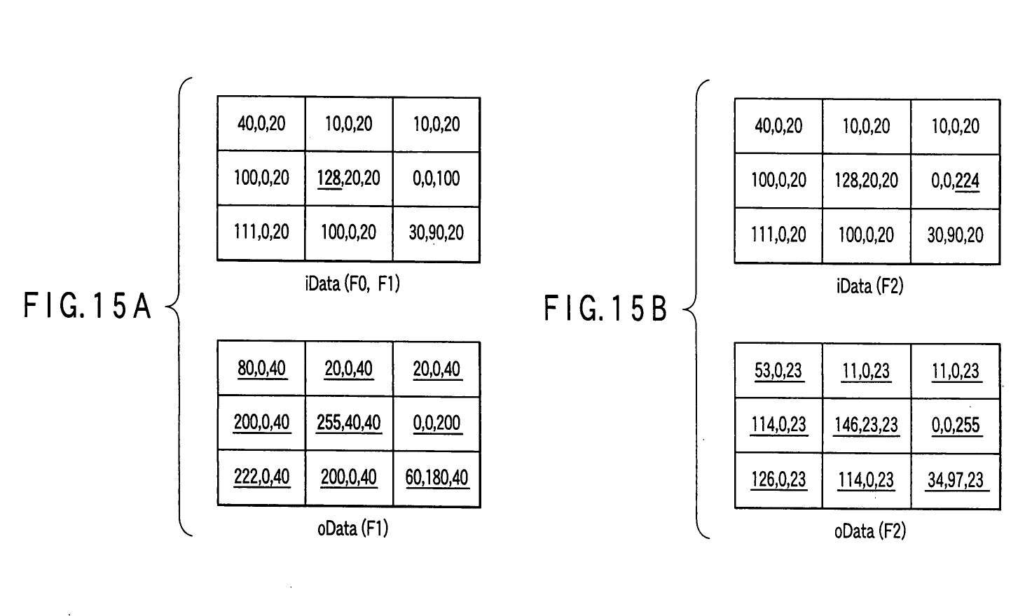

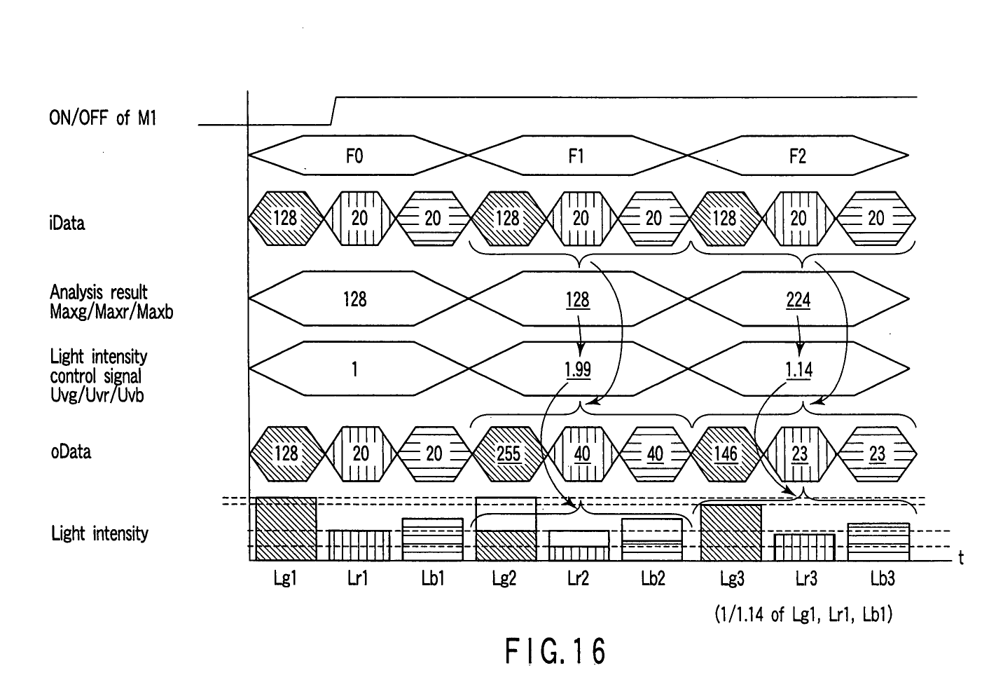

For example, it is assumed that the inputted data iData is pixel data such as shown in FIG. 15A (it is illustrated as data composed of 3×3 pixels in the drawing for the convenience's sake. Moreover, numeric values of the respective pixels sequentially indicate respective data of G, R and B). Like a frame F0 in a timing chart of FIG. 16, in the mode OFF before the M1 button is turned on, the data scale factors Uvg, Uvr and Uvb are “1” as described above. Here, it is assumed that the M1 button is turned on and the mode is changed to the energy saving mode M1. In this case, even if a frame F1 which is a subsequent frame has the same inputted data iData as that of the frame F0, the image analysis portion 322 determines each of G data, R data and B data for one pixel as one set of data, detects the MAX value of all data of the inputted data iData, and outputs the data scale factors Uvg, Uvr and Uvb as the light intensity control signals having the same value. In the example shown in FIG. 15A, “128” which is G data of a central pixel is detected as the MAX value. Then, the image analysis portion 322 sets “1.99” which is a 255/MAX value to the data scale factors Uvg, Uvr and Uvb, and outputs a result as the light intensity control signal.

Upon receiving the light intensity control signal, the scale conversion portion 323 multiplies data of each pixel by 1.99, thereby obtains output data oData acquired by multiplying data of each pixel for each color by 1.99, and outputs it to the image correction portion 324. The image correction portion 324 obtains optical modulation data by applying image correction to the output data oData, and supplies it to the optical modulation device 30.

On the other hand, the supply current adjustment control portion 24 controls the supply currents to the respective LEDs 26G, 26R and 26B in accordance with the light intensity control signal in such a manner that respective light intensities Lg2, Lr2 and Lb2 of G, R and B in the frame F1 detected by the light sensor 34 become light intensities which are 1/Uvg-, 1/Uvr- and 1/Uvb-fold, i.e., 1/1.99-fold of light intensities Lg1, Lr1 and Lb1 in the frame F0 as shown in FIG. 16.

Then, when the data is changed to iData such as shown in FIG. 15B in a frame F2, the image analysis portion 322 likewise detects an MAX value of all data of the inputted data iData. In this case, it detects “224” which is B data of a pixel at a right column and a central stage as the MAX value. Then, the image analysis portion 322 sets “1.14” which is a 255/MAX value to the data scale factors Uvg, Uvr and Uvb, and outputs a result as the light intensity control signal.

Upon receiving this light intensity control signal, the scale conversion portion 323 acquires output data oData obtained by multiplying data of each pixel for each color by 1.14 and outputs it to the image correction portion 324 as shown in FIGS. 15B and 16. The image correction portion 324 acquires optical modulation data by applying image correction to the output data oData, and supplies it to the optical modulation device 30. It is to be noted that the attention is paid to only the central pixel in the 3×3 pixels in each frame, and iData, oData and the light intensities are illustrated in the timing chart of FIG. 16.

Further, on the other hand, the supply current adjustment control portion 24 controls the supply currents to the respective LEDs 26G, 26R and 26B in accordance with the light intensity control signal in such a manner that the respective light intensities Lg3, Lr3 and Lb3 of G, R and B in the frame F2 detected by the light sensor 34 become light intensities which are 1/Uvg-, 1/Uvr- and 1/Uvb-fold, i.e., 1/1.14-fold of the light intensities Lg1, Lr1 and Lb1 in the frame F0 as the light intensity reference values as shown in FIG. 16.

Furthermore, the energy saving mode M2 in which the M2 button in the setting buttons 46 is turned on is the mode to detect a maximum value of all data of each of G, R and B by image analysis and perform the operation as described above. Therefore, the image analysis portion 322 detects an MAX value of all data of inputted data iData from the inverse gamma correction portion 321 in accordance with each of G, R and B, and outputs data scale factors Uvg, Uvr and Uvb as light intensity control signals in accordance with each of G, R and B.

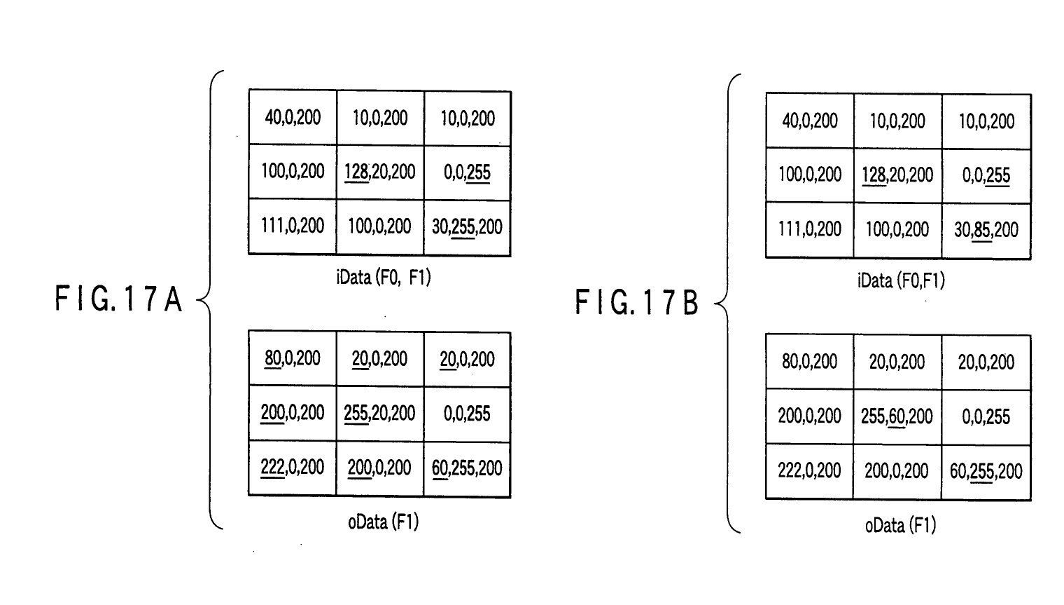

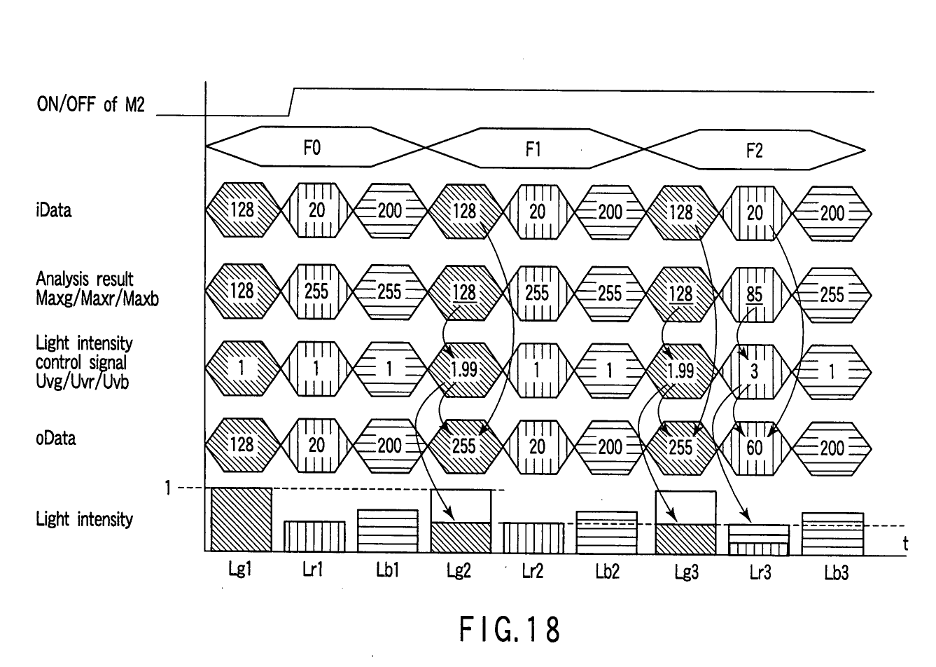

For example, it is assumed that the inputted data iData is pixel data such as shown in FIG. 17A. Moreover, it is presumed that the M2 button is turned on to enter the energy saving mode M2 during projection display of the frame F0 as shown in a timing chart of FIG. 18. At this time, even if the next frame F1 has the same inputted data iData as that in the frame F0, the image analysis portion 322 detects an MAX value of all data of the inputted data iData from the inverse gamma correction portion 321 in accordance with each of G, R and B. That is, a value “128” of a central pixel 128 is detected as an MAX value MAXg of G data, a value “255” of a pixel at a right column and a low stage is detected as an MAX value MAXr of R data, and a value “255” of a pixel at the right column and a central stage is detected as an MAX value MAXb of B data, respectively. Here, the image analysis portion 322 outputs data scale factors Uvg=255/MAXr=255/128=1.99, Uvr=255/MAXr=255/255=1, and Uvb=255/MAXb=255/255=1 as light intensity control signals in accordance with G, R and B.

Upon receiving the light intensity control signals, the scale conversion portion 323 obtains output data oData such as shown in FIGS. 17A and 18 by multiplying data of each pixel by 1.99 in case of G data and 1 in case of R data and B data, and outputs it to the image correction portion 324. The image correction portion 324 obtains optical modulation data by applying image correction to the output data oData, and supplies it to the optical modulation device 30.

Additionally, on the other hand, the supply current adjustment control portion 24 controls the supply currents to the respective LEDs 26G, 26R and 26B in accordance with the light intensity control signals in such a manner that the respective light intensities Lg2, Lr2 and Lb2 of G, R and B in the frame F1 detected by the light sensor 34 become light intensities which are 1/Uvg-, 1/Uvr- and 1/Uvb-fold, i.e., 1/1.99-, 1/1- and 1/1-fold of the light intensities Lg1, Lr1 and Lb1 in the frame F0 as the light intensity reference values as shown in FIG. 18.

Then, when the data is changed to iData such as shown in FIG. 17B in the frame F2, the image analysis portion 322 likewise detects an MAX value of all data of the inputted data iData. In this case, it detects a value “128” of a central pixel as an MAX value MAXg of G data, a value “85” of a pixel at the right column and the lower stage as an MAX value MAXr of R data, and a value “255” of a pixel at the right column and the central stage as an MAX value MAXb of B data, respectively. Then, it outputs data scale factors Uvg=255/128=1.99, Uvr=255/85=3 and Uvb=255/255=1 as light intensity control signals in accordance with G, R and B.

Upon receiving the light intensity control signals, the scale conversion portion 323 acquires output data oData obtained by multiplying data of each pixel by 1.99 in case of G data, 3 in case of R data and 1 in case of B data as shown in FIGS. 17B and 18, and outputs it to the image correction portion 324. The image correction portion 324 obtains optical modulation data by applying image correction to the output data oData, and supplies it to the optical modulation device 30.

Further, on the other hand, the supply current adjustment control portion 24 controls the supply currents to the respective LEDs 26G, 26R and 26B in accordance with the light intensity control signals in such a manner that the respective light intensities Lg3, Lr3 and Lb3 of G, R and B in the frame F2 detected by the light sensor 34 become light intensities which are 1/Uvg-, 1/Uvr- and 1/Uvb-fold, i.e., 1/1.99-, 1/3- and 1/1-fold of the light intensities Lg1, Lr1 and Lb1 in the frame F0 as the light intensity reference values as shown in FIG. 18.

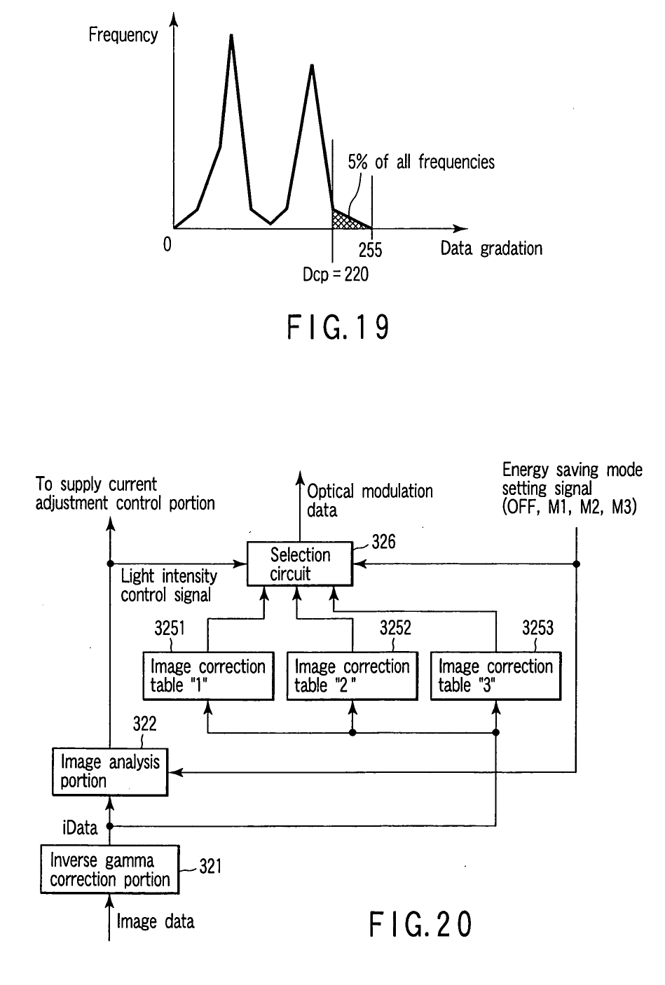

Furthermore, the energy saving mode M3 in which the M3 button in the setting buttons 46 is turned on is the mode to detect a histogram of all data in accordance with each of G, R and B by image analysis and perform the operation as described above. Therefore, as shown in FIG. 19, the image analysis portion 322 applies histogram processing to all data of inputted data iData from the inverse gamma correction portion 321 in accordance with R, G and B, detects a data value Hy-5% corresponding to a frequency of top 5% of entire frequencies, and outputs data scale factors Uvg, Uvr and Uvb as light intensity control signals in accordance with R, G and B.

The scale conversion portion 323 receives the resulting data scale factors Uvg, Uvr and Uvb, converts the scales to oDg=iDg×Uvg, oDr=iDr×Uvr and oDb=iDb×Uvb provided that G, R and B data of oData are oData (oDg, oDr, oDb), and outputs oData (oDg, oDr, oDb). At this time, oData of pixels larger than Dcp in FIG. 19 are all restricted to 255. As a result, an image finally projected onto the screen S or the like is different from that in the mode OFF. However, when there is the pixel defect, the image has no problem, and a deterioration in image quality due to a defective pixel cannot be disturbing. However, it is determined that data that the oData resulting from scale conversion exceeds 255 is converted into 255.

As described above, according to the third embodiment, when a light emission quantity is changed with controls of various devices, this change is complemented and the conversion method is changed. As a result, a stable image can be continuously displayed without changing a brightness of the image observed by observers. Moreover, a light intensity can be adjusted to the maximum level while maintaining the brightness and the image quality of an image to be displayed. Additionally, a light emission quantity with which the image quality can be completely maintained can be adjusted.

Further, in the energy saving mode M1, a light emission quantity can be adjusted to the maximum level while substantially maintaining the image quality. Furthermore, the conversion method can be common to respective colors, thereby simplifying the structure. Moreover, in the energy saving mode M2, a light emission quantity can be adjusted to the maximum level while substantially maintaining the image quality. In particular, in a scene of a movie of the like known for a small maximum value of image data, a light emission quantity can be greatly adjusted, and the energy saving effect can be expected. Additionally, in these energy saving modes M1 and M2, a light emission quantity can be adjusted as much as possible by adjusting the light intensity quantity with respect to a dynamic change in image data. Further, in the energy saving mode M3, a light emission quantity can be adjusted to the maximum level while substantially maintaining the image quality. In particular, it is possible to remove only one pixel having large image data in a dark image due to a pixel defect or the like which is generated in the image data when fetched by a camera, and a light emission quantity can be likewise adjusted to the maximum level in such a case.

It is to be noted that the analysis processing is described as the histogram in the energy saving mode M3, but the present invention is not restricted thereto. For example, filtering processing using a low pass filter or the like may be applied to an image, and then an MAX may be detected. The energy saving effect can be obtained with respect to an image having the above-described image defect even in case of the MAX detection processing described in connection with the energy saving modes M1 and M2 after the filtering processing of image data or iData.

Furthermore, the optical modulation data change portion of the optical modulation device control portion 32 may be constituted of a plurality of lookup tables. That is, there are used a plurality of image correction tables 3251 to 3253 and a selection circuit 326 which selects the plurality of image correction tables 3251 to 3253 in synchronization with a vertical synchronization signal in place of the scale conversion portion 323 and the image correction portion 324, as shown in FIG. 20. It is to be noted that the image correction tables 3251 to 3253 are constituted of an ROM. Of course, they may be constituted of an RAM so that their contents can be changed.

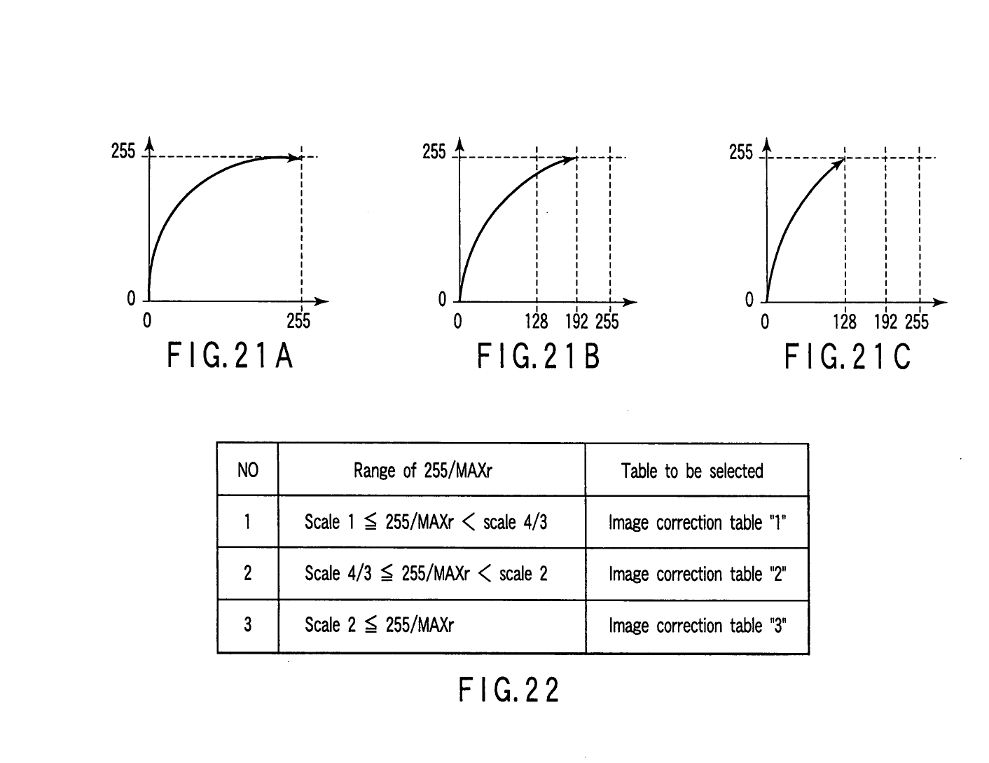

Here, the image correction table “1” 3251 is a table for a scale 1, and it is obtained by forming a table of such a content as shown in FIG. 21A. It is to be noted that this is a content including the gamma and hence the image correction operation is not required. Moreover, the image correction table “2” 3252 is a table for a scale 4/3, and it is obtained by forming a table of such a content as shown in FIG. 21B. Additionally, the image correction table “3” 3253 is a table for a scale 2, and it is obtained by forming such a content as shown in FIG. 21C.

Additionally, in this case, the image analysis portion 322 does not output the data scale factors Uvg, Uvr and Uvb as light intensity control signals but outputs MAXr, MAXg and MAXb as analysis results in the energy saving mode M2. The selection circuit 326 compares the scales 1, 4/3 and 2 in the respective tables with 255/MAXr, 255/MAXg and 255/MAXb, reduces light intensities as much as possible, and selects a table so as to obtain a projection image corresponding to image data.

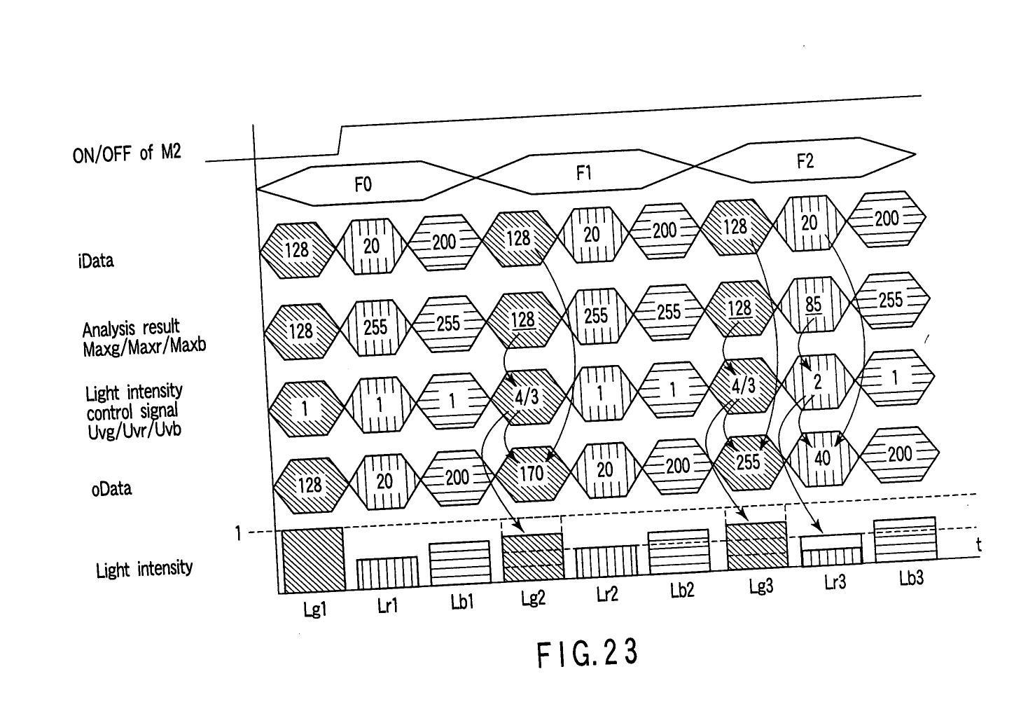

The selection table 326 selects the image correction tables 3251 to 3253 in accordance with conditions such as shown in FIG. 22. For example, when the maximum value MAXr of the detected R data is “85”, 255/MAXr=255/85=3 is achieved, and this value “3” is. not less than “2”. Therefore, the image correction table “3” 3253 is selected. Further, when the maximum value MAXr of the R data is “128”, 255/MAXr=255/128=1.99 is achieved, and this value “1.99” is not less than “4/3” and less than “2”. Therefore, the image correction table “2” 3252 is selected. As a result, such a timing chart as shown in FIG. 23 is obtained. The selection circuit 326 recognizes types or an information amount of light intensity control signals corresponding to the energy saving mode based on an energy saving mode setting signal. For example, the light intensity control signals are three signals, i.e., MAXr, MAXg and MAXb in the mode M2, and the light intensity control signal is one signal MAX in the mode M1.

Since just switching the lookup tables can suffice in this manner, optical modulation data can be generated and converted at a high speed in accordance with each frame and each field.

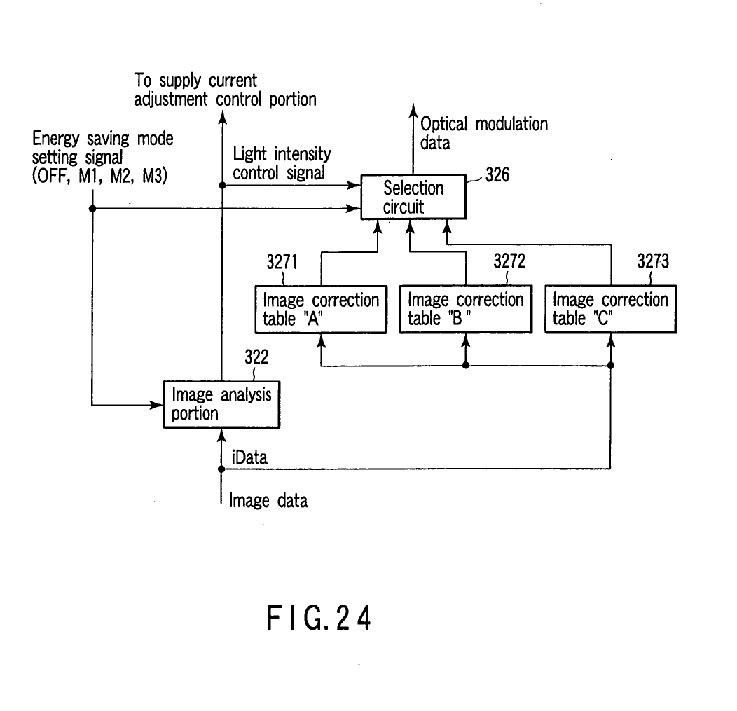

Furthermore, the lookup tables can include an inverse gamma correction function for inputted image data. That is, as shown in FIG. 24, the optical modulation device control portion 32 can be constituted of an image analysis portion 322, a plurality of image correction tables 3271 to 3273 and a selection circuit 326, and the reserve gamma correction portion 321 can be eliminated. In this case, the image analysis portion 322 may perform the same processing as that in the modification of FIG. 20 which detects MAX in the energy saving modes M1 and M2. In the energy saving mode M3, since a graph shape of the histogram transforms for the inverse gamma, the same result as that in FIG. 20 can be obtained by setting a new frequency value corresponding to Hy-5% in accordance with this transformation. Moreover, the image correction table “A” 3271, the image correction table “B” 3272 and the image correction table “C” 3273 are respectively set based on a relationship between the inverse gamma, the scale conversion and the correction curve of image correction.

According to such a structure, the inverse gamma correction portion 321 is no longer necessary, the structure becomes simple and small, and the apparatus can be inexpensively configured.

As described above, the optical modulation data change portion has a structure in which a plurality of lookup tables formed of a preset ROM or the like are prepared and they are selected, thereby rapidly changing the conversion method.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A display apparatus which displays an image to an observer by using an optical modulation device which performs optical modulation in accordance with inputted image data, comprising:
a plurality of light emitters configured to emit different color light beams whose light emission quantities are adjustable; and
a light intensity adjustment control portion configured to individually adjust and control the light emission quantities of the respective color light beams emitted by the plurality of light emitters,
the light intensity adjustment control portion being able to change a light emission quantity of at least one color light beam to a light emission quantity smaller than the light emission quantities of the respective color light beams from the plurality of light emitters when a white image having a maximum brightness which can be displayed is displayed to an observer.

2. The apparatus according to claim 1, further comprising an optical modulation data change portion configured to obtain optical modulation data by converting a size of the inputted image data, and input the converted optical modulation data to the optical modulation device, wherein
in order to prevent a brightness of an image based on a predetermined size of image data observed by an observer from being changed,
the optical modulation data change portion changes a conversion method performed by itself, and
the light intensity adjustment control portion changes the light emission quantities of the respective color light beams emitted by the plurality of light emitters.

3. The apparatus according to claim 1, further comprising an operation panel configured to command adjustment of the light emission quantities of the respective color light beams emitted from the plurality of light emitters by an operator, wherein
the light intensity adjustment control portion individually adjusts and controls the light emission quantities of the respective color light beams emitted from the plurality of light emitters in accordance with an adjustment command from the operation panel.

4. The apparatus according to claim 3, wherein the light intensity adjustment control portion individually adjusts and controls the light emission quantities of the respective color light beams so as to adjust the white balance of the color light beams emitted from the plurality of light emitters when adjusting the light emission quantities in accordance with the adjustment command.

5. The apparatus according to claim 2, further comprising an image analysis portion configured to analyze the inputted image data and output a signal corresponding to an analysis result, wherein
the optical modulation data change portion changes a conversion method in accordance with an output signal from the image analysis portion, and
the light intensity adjustment control portion changes the light emission quantities in accordance with an output signal from the image analysis portion.

6. The apparatus according to claim 5, wherein the image analysis portion detects a maximum value of the inputted image data and outputs it as an analysis result.

7. The apparatus according to claim 6, wherein
the different color light beams are red, blue and green,
the inputted image data is composed of data corresponding to the respective color light beams,
the image analysis portion outputs respective analysis results of the data corresponding to the respective color light beams,
the optical modulation data change portion changes the conversion method for each color light beam in accordance with the maximum value for each color light beam detected by the image analysis portion, and
the light intensity adjustment control portion changes the light emission quantity of each color light beam in accordance with the conversion method for each color light beam.

8. The apparatus according to claim 6, wherein
the different color light beams are red, blue and green,
the inputted image data is composed of data corresponding to the respective color light beams,
the image analysis portion determines the data corresponding to each of the color light beams as all data, and outputs an analysis result concerning the all data,
the optical modulation data change portion changes the conversion method for each color light beam in accordance with a maximum value concerning the all data detected by the image analysis portion, and
the light intensity adjustment control portion changes the light emission quantity of each color light beam in accordance with the conversion method.

9. The apparatus according to claim 5, wherein the image analysis portion generates a histogram of the inputted image data, and outputs it as an analysis result.

10. The apparatus according to claim 5, wherein the light intensity adjustment control portion changes the light emission quantity of each color light beam emitted from the plurality of light emitters every time the inputted image data is changed.

11. The apparatus according to claim 5, wherein
the optical modulation data change portion comprises a plurality of lookup tables as a predetermined conversion method in which a relationship between the image data and the optical modulation data is preset, and
the optical modulation data change portion selects one of the plurality of lookup tables in accordance with an output from the image analysis portion.

12. The apparatus according to claim 1, wherein the light emitter comprises a plurality of light emitting diodes which emit light beams having at least one color,
the light intensity adjustment control portion causes the plurality of light emitting diodes to perform pulse light emission with different timings, and
the light intensity adjustment control portion performs light intensity adjustment by changing respective light emission quantities of the light emitting diodes which emit light beams with different timings.

13. The apparatus according to claim 12, wherein the light intensity adjustment control portion controls supply currents to the light emitting diodes when performing the light intensity adjustment by changing the light emission quantities of the light emitting diodes.

14. The apparatus according to claim 12, wherein the light intensity adjustment control portion controls a pulse light emission time in which the light emitting diodes are caused to emit light beams when performing the light intensity adjustment by changing the light emission quantities of the light emitting diodes.

15. The apparatus according to claim 12, further comprising:
a light source holding portion configured to arrange the plurality of light emitting diodes in a ring form, the light intensity adjustment control portion controlling the plurality of light emitting diodes to sequentially perform pulse light emission in accordance with an arrangement order that the plurality of light emitting diodes are held in the light source holding portion; and
a drive control portion configured to drive and control a light leading member to rotate along the light emitting diodes arranged in the ring form in order to lead the respective light beams at the time of sequential pulse light emission of the light emitting diodes to the optical modulation device by the light leading member.

16. The apparatus according to claim 1, further comprising a projection optical system configured to magnify and project light beams optically modulated by the optical modulation device.

17. A display apparatus which displays an image to an observer by using an optical modulation device which performs optical modulation in accordance with inputted image data, comprising:
a plurality of light emitters for emitting different color light beams whose light emission quantities are adjustable; and
light intensity adjustment control means for individually adjusting and controlling the light emission quantities of the respective color light beams emitted by the plurality of light emitters,
the light intensity adjustment control means being able to change a light emission quantity of at least one color light beam to a light emission quantity smaller than the light emission quantities of the respective color light beams from the plurality of light emitters when a white image having a maximum brightness which can be displayed is displayed to an observer.
